(19) United States
(12) Patent Application Publication
(10) Pub. No.: US 2023/0370527 A1
(43) Pub. Date: Nov. 16, 2023

(54) NETWORK NODE, TERMINAL DEVICE, AND METHODS THEREIN FOR EDGE APPLICATIONS

(71) Applicant: Telefonaktiebolaget LM Ericsson (publ), Stockholm (SE)

(72) Inventor: Wenliang Xu, Shanghai (CN)

(21) Appl. No.: 18/027,979

(22) PCT Filed: Aug. 20, 2021
(86) PCT No.: PCT/CN2021/113740

§ 371 Date: Mar. 23, 2023

(30) Foreign Application Priority Data
Sep. 29, 2020 (WO) PCT/CN2020/118796

(51) Int. Cl. H04L 67/51; H04L 67/30

(52) U.S. Cl. CPC H04L 67/51; H04L 67/30

(57) ABSTRACT

The present disclosure provides a method in a network node implementing an Edge Enabler Server, EES. The method includes: transmitting, to an Edge Configuration Server, ECS, a registration request or a registration update request containing one or more Data Network Access Identifiers, DNAIs, associated with an Edge Application Server, EAS, or the EES. The EAS is registered with the EES.

### TECHNICAL FIELD

The present disclosure relates to communication technology, and more particularly, to a network node, a terminal device, and methods therein for edge applications.

### BACKGROUND

The 3rd Generation Partnership Project (3GPP) Technical Specification (TS) 23.558, V1.0.0, which is incorporated herein by reference in its entirety, specifies application layer architecture, procedures and information flows necessary for enabling edge applications over 3GPP networks. It includes architectural requirements for enabling edge applications, application layer architecture fulfilling the architecture requirements and procedures to enable the deployment of edge applications.

One of the main areas focused on is to minimize the impact on edge based applications, so they do not need major application redevelopment for use by User Equipments (UEs) at the edge.

FIG. 1 shows an architecture for enabling edge applications. As shown, an Edge Data Network (EDN) is a local data network. One or more Edge Application Servers (EASs) and Edge Enabler Servers (EESs) are contained within the EDN. An EAS is an application server resident in the EDN, performing server functions. The Application Client connects to the EAS in order to avail services of the application with the benefits of Edge Computing. An EES provides supporting functions needed for EASs and Edge Enabler Clients (EECs). An Edge Configuration Server (ECS) provides supporting functions needed for an EEC to connect with an EES. A UE contains one or more Application Clients and EECs. An EEC provides supporting functions needed for the Application Client(s). The EASs, the EESs, and the ECS may interact with a 3GPP Core Network (CN). FIG. 1 also shows reference points or interfaces used in the architecture, among which:

EDGE-3 reference point enables interactions between the EES and the EAS, and supports registration of the EAS with the EES;

EDGE-4 reference point enables interactions between the ECS and the EEC, and supports provisioning of edge configuration information to the EEC; and

EDGE-6 reference point enables interactions between the ECS and the EES, and supports registration of EES information to the ECS.

FIG. 2 shows a procedure for EES registration as defined Section 8.4.4.2.2 of TS 23.558. At 2.1, an EES sends an EES registration request to an ECS. The request from the EES includes an EES identity (ID), EES Point of Contact information, EAS Profiles of registered EASs and EES security credentials. The request may include a proposed expiration time for the registration. At 2.2, upon receiving the request from the EES, the ECS verifies the security credentials of the EES and stores the EES registration information obtained in step 2.1. At 2.3, the ECS sends an EES registration response indicating success or failure of the registration operation. The ECS may provide an updated expiration time to indicate to the EES when the registration will automatically expire. To maintain the registration, the EES shall send a registration update request prior to the expiration time. If a registration update request is not received prior to the expiration time, the ECS shall treat the EES as implicitly de-registered.

FIG. 3 shows an EES registration update procedure as defined in Section 8.4.4.2.3 of TS 23.558. At 3.1, an EES sends an EES registration update request to an ECS. The request from the EES includes a registration identity and EES security credentials, and may include proposed expiration time, EES Point of Contact information, EAS Profiles of registered EASs. At 3.2, upon receiving the request from the EES, the ECS verifies the security credentials of the EES and stores the updated EES registration information obtained in step 3.1. At 3.3, the ECS sends an EES registration update response indicating success or failure of the registration operation. The ECS may provide an updated expiration time to indicate to the EES when the updated registration will automatically expire. To maintain the registration, the EES shall send a registration update request prior to the expiration time. If a registration update request is not received prior to the expiration time, the ECS shall treat the EES as implicitly de-registered.

FIG. 4 shows an EAS discovery procedure, as defined in Section 8.8.3 of TS 35 23.558. At 4.1, a source EAS invokes an EAS discovery request on a source EES.

The EAS discovery request includes the requestor identifier (EAS ID) along with security credentials and includes EAS discovery filter matching its Edge application Server profile. If a target Data Network Access Identifier (DNAI) is available at the source EAS via User Plane (UP) path management event notification, the source EAS provides the source EES with the target DNAI. At 4.2, upon receiving the request, the source EES checks if the requesting EAS is authorized to perform the discovery operation. If it is authorized, the source EES checks if there exists target EAS information (registered or cached) that can satisfy the requesting EAS information and additional query filters. If the source EES discovers the target EAS(s), the flow continues with step 4.5, else the source EES retrieves a target EES address from an ECS. At. 4.3, the source EES invokes the EAS discovery request on the target EES. The source EES discovery request includes a requestor identifier (EES ID) along with security credentials and includes EAS discovery filter obtained in step 4.1. At 4.4, the target EES discovers the target EAS(s) and responds with the discovered target EAS information to the source EES. The source EES may cache the target EAS information. At 4.5, the source EES responds to the source EAS with the target EAS Information.

Here, a DNAI is defined in Section 3.1 of the 3GPP TS 23.501, V16.6.0, which is incorporated herein by reference in its entirety, as identifier of a UP access to one or more data networks (e.g., EDNs) where applications are deployed.

The step 4.2 in FIG. 4 can be further explained with reference to FIG. 5, which shows a Retrieve target Edge Enabler Server procedure. If the source EES cannot find the target EAS, at 5.1, the source EES sends a Retrieve Edge Enabler Server request (containing UE location information or UE identity, EAS ID of the source EAS, target DNAI) to the ECS in order to identify the target EES which has an Edge Application Server available to serve the given Application Client in the UE. At 5.2, if the request contains the UE identity but the UE location is not known to the ECS, then the ECS interacts with the 3GPP CN to retrieve the UE location. The ECS determines target EES(s) as per the parameters (e.g., EAS ID, target DNAI) in the request and the UE location information. At 5.3., the ECS sends a Retrieve Edge Enabler Server response (containing EAS ID of the source EAS, list of target EES(s) information) to the source EES. The list of target EES(s) information includes an endpoint for each of the target EES(s), e.g., Internet Protocol (IP) address determined in step 5.2.

Section 8.3 of TS 23.558 specifies service provisioning, which allows configuring an EEC with information about available edge computing services, based on the hosting UE's location, service requirements, service preferences and connectivity. This configuration includes necessary address information for the EEC to establish connection with the EES(s).

FIG. 6 shows a procedure for service provisioning subscription as defined in Section 8.3.2.4.2 of TS 23.588. At 6.1, an EEC sends a service provisioning subscription request to an ECS. The service provisioning subscription request includes security credentials of the EEC received during EEC authorization procedure and may include the UE identifier, connectivity information, proposed expiration time and Application Client Profile information. At 6.2, upon receiving the request, the ECS performs an authorization check to verify whether the EEC has authorization to perform the operation. If required, the ECS may utilize the capabilities (e.g., UE location) of the 3GPP CN. If the request is authorized, the ECS creates and stores the subscription for provisioning. At 6.3, the ECS responds with a service provisioning subscription response, which includes the subscription identifier and may include the expiration time, indicating when the subscription will automatically expire. To maintain the subscription, the EEC shall send a service provisioning subscription update request prior to the expiration time. If a service provisioning subscription update request is not received prior to the expiration time, the ECS shall treat the EEC as implicitly unsubscribed.

FIG. 7 shows a service provisioning subscription update procedure as defined in Section 8.3.2.4.4 of TS 23.558. At 7.1, an EEC sends a service provisioning subscription update request to an ECS. The service provisioning subscription update request includes security credentials of the EEC received during EEC authorization procedure along with the subscription identifier and may include the UE identifier, connectivity information, proposed expiration time for the updated subscription and Application Client profile(s). At 7.2, upon receiving the request, the ECS performs an authorization check to verify whether the EEC has authorization to perform the operation. If required, the ECS may utilize the capabilities (e.g. UE location) of the 3GPP CN. If authorized, the ECS updates the stored subscription for provisioning as requested in step 7.1. At 7.3, the ECS responds with a service provisioning subscription update response, which may include the expiration time, indicating when the updated subscription will automatically expire. To maintain the subscription, the EEC shall send a Service provisioning subscription update request prior to the expiration time. If a Service provisioning subscription update request is not received prior to the expiration time, the ECS shall treat the EEC as implicitly unsubscribed.

FIG. 8 shows a procedure for service provisioning notification as defined in Section 8.3.2.4.3 of TS 23.588. At 8.1, an event occurs at an ECS that satisfies trigger conditions for updating service provisioning of a subscribed EEC. If UE's location information is not available, the ECS may obtain the UE location by utilizing the capabilities of the 3GPP CN. The ECS determines EESs based on UE's location information, which match the Application Client profile(s). The ECS also determines other information that needs to be provisioned, e.g. identification of the EDN, service area information (for Local Area DN (LADN)), EES endpoints. At 8.2, the ECS sends a provisioning notification to the EEC with the list of EDN configuration information determined in step 8.1.

For further details of the above procedures, reference can be made to TS 23.558 and description thereof will be omitted here.

### SUMMARY

As described above in connection with FIG. 5, the Retrieve Edge Enabler Server request in the step 5.1 may contain a target DNAI. In order to find a target EES which can serve a target EAS with the target DNAI, the ECS needs to know the DNAI of the target EAS. However, such information is not available at the ECS.

Moreover, in the service provisioning notification procedure as described above in connection with FIG. 8, without the knowledge of DNAI, the ECS cannot push information on a target EES which can serve a target EAS with a target DNAI to the EEC.

In addition, in the service provisioning subscription and notification procedures as described above in connection with FIGS. 6-8, no endpoint information (i.e., IP address, port number, and transport layer protocol) of an EAS having application data traffic to/from Application Client(s) is available at the ECS, so the ECS cannot utilize the UP path management capability provided by the 3GPP CN as described in TS 23.501 and TS 23.502, V16.6.0, which in incorporated herein by reference in its entirety.

It is an object of the present disclosure to provide a network node, a terminal device, and methods therein, capable of solving at least one of the above problems.

According to a first aspect of the present disclosure, a method in a network node implementing an EES is provided. The method includes: transmitting, to an ECS, a registration request or a registration update request containing one or more DNAIs associated with an EAS or the EES. The EAS is registered with the EES.

In an embodiment, the one or more DNAIs may be included in an EES profile or an EAS profile in the registration request or the registration update request.

According to a second aspect of the present disclosure, a network node is provided. The network node includes a communication interface, a processor and a memory. The memory contains instructions executable by the processor whereby the network node is operative to, when implementing an EES, perform the method according to the above first aspect.

According to a third aspect of the present disclosure, a computer-readable storage medium is provided. The computer-readable storage medium has computer-readable instructions stored thereon. The computer-readable instructions, when executed by a processor of a network node, configure the network node to, when implementing an EES, perform the method according to the above first aspect.

According to a fourth aspect of the present disclosure, a method in a network node implementing an ECS is provided. The method includes: receiving, from an EES, a registration request or a registration update request containing one or more DNAIs associated with an EAS or the EES. The EAS is registered with the EES.

In an embodiment, the one or more DNAIs may be included in an EES profile or an EAS profile in the registration request or the registration update request.

In an embodiment, the method may further include: receiving, from a source EES, a retrieve EES request for retrieving one or more target EESs, the retrieve EES request containing a target DNAI; and transmitting, to the source EES, a retrieve EES response containing information on the one or more target EESs associated with the target DNAI.

In an embodiment, at least one of the one or more DNAIs associated with the EAS or EES may match the target DNAI.

In an embodiment, the method may further include: receiving, from a terminal device implementing an EEC, a service provisioning subscription request or a service provisioning subscription update request containing EAS endpoint information of a selected EAS for application traffic; receiving, from a CN node, a notification of a UP path management event associated with the application traffic, the notification containing a target DNAI for the application traffic; and transmitting, to the terminal device, a service provisioning notification containing information on the EES, when at least one of the one or more DNAIs associated with the EAS or the EES match the target DNAI.

In an embodiment, the UP path management event may include DNAI change.

In an embodiment, the EAS endpoint information may include an IP address, a port number, a transport layer protocol, a Fully Qualified Domain Name (FQDN), and/or a Uniform Resource Identifier (URI) associated with the selected EAS.

According to a fifth aspect of the present disclosure, a method in a network node implementing an ECS is provided. The method includes: receiving, from a terminal device implementing an EEC, a service provisioning subscription request or a service provisioning subscription update request containing EAS endpoint information of a selected EAS for application traffic.

In an embodiment, the method may further include: receiving, from a CN node, a notification of a UP path management event associated with the application traffic, the notification containing a target DNAI for the application traffic; and transmitting, to the terminal device, a service provisioning notification containing information on an EES when a DNAI associated with an EAS matches the target DNAI. The EAS is registered with the EES.

In an embodiment, the UP path management event may include DNAI change.

In an embodiment, the EAS endpoint information may include an IP address, a port number, a transport layer protocol, a FQDN, and/or a URI associated with the selected EAS.

According to a sixth aspect of the present disclosure, a network node is provided. The network node includes a communication interface, a processor and a memory. The memory contains instructions executable by the processor whereby the network node is operative to, when implementing an ECS, perform the method according to the above fourth or fifth aspect.

According to a seventh aspect of the present disclosure, a computer-readable storage medium is provided. The computer-readable storage medium has computer-readable instructions stored thereon. The computer-readable instructions, when executed by a processor of a network node, configure the network node to, when implementing an ECS, perform the method according to the above fourth or fifth aspect.

According to an eighth aspect of the present disclosure, a method in a terminal device implementing an EEC is provided. The method includes: transmitting, to a network node implementing an ECS, a service provisioning subscription request or a service provisioning subscription update request containing EAS endpoint information of a selected EAS for application traffic.

In an embodiment, the EAS endpoint information may include an IP address, a port number, a transport layer protocol, a FQDN, and/or a URI associated with the selected EAS.

According to a ninth aspect of the present disclosure, a terminal device is provided. The terminal device includes a communication interface, a processor and a memory. The memory contains instructions executable by the processor whereby the terminal device is operative to, when implementing an EEC, perform the method according to the above eighth aspect.

According to a tenth aspect of the present disclosure, a computer-readable storage medium is provided. The computer-readable storage medium has computer-readable instructions stored thereon. The computer-readable instructions, when executed by a processor of a terminal device, configure the terminal device to, when implementing an EEC, perform the method according to the above eighth aspect.

With the embodiments of the present disclosure, a registration request (or registration update request) from an EES to an ECS can contain a DNAI associated with an EAS that is registered with the EES. With the DNAI, the ECS is enabled to determine the EES as an appropriate target EES that can serve the EAS with the DNAI. On the other hand, a service provisioning subscription request (or service provisioning subscription update request) from an EEC to an ECS may contain EAS endpoint information of a selected EAS for application traffic. With the EAS endpoint information, the ECS is enabled to utilize the UP path management capability provided by the 3GPP CN.

### BRIEF DESCRIPTION OF THE DRAWINGS

The above and other objects, features and advantages will be more apparent from the following description of embodiments with reference to the figures, in which:

FIG. 1 is a schematic diagram showing an architecture for enabling edge applications;

FIG. 2 is a sequence diagram showing an EES registration procedure;

FIG. 3 is a sequence diagram showing an EES registration update procedure;

FIG. 4 is a sequence diagram showing an EAS discovery procedure;

FIG. 5 is a sequence diagram showing a retrieve target EES procedure;

FIG. 6 is a sequence diagram showing a service provisioning subscription procedure;

FIG. 7 is a sequence diagram showing a service provisioning subscription update procedure;

FIG. 8 is a sequence diagram showing a service provisioning notification procedure;

FIG. 9 is a flowchart illustrating a method in an EES according to an embodiment of the present disclosure;

FIG. 10 is a flowchart illustrating a method in an ECS according to an embodiment of the present disclosure;

FIG. 11 is a flowchart illustrating a method in an ECS according to another embodiment of the present disclosure;

FIG. 12 is a flowchart illustrating a method in an EEC according to an embodiment of the present disclosure;

FIG. 13 is a block diagram of a network node implementing an EES according to an embodiment of the present disclosure;

FIG. 14 is a block diagram of a network node implementing an EES according to another embodiment of the present disclosure;

FIG. 15 is a block diagram of a network node implementing an ECS according to an embodiment of the present disclosure;

FIG. 16 is a block diagram of a network node implementing an ECS according to another embodiment of the present disclosure;

FIG. 17 is a block diagram of a terminal device according to an embodiment of the present disclosure; and

FIG. 18 is a block diagram of a terminal device according to another embodiment of the present disclosure.

### DETAILED DESCRIPTION

In the present disclosure, a server or a client can be implemented either as a network element on a dedicated hardware, as a software instance running on a dedicated hardware, or as a virtualized function instantiated on an appropriate platform, e.g. on a cloud infrastructure.

References in the specification to “one embodiment, ” “an embodiment, ” “an example embodiment, ” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

FIG. 9 is a flowchart illustrating a method 900 according to an embodiment of the present disclosure. The method 900 can be performed at an EES or a network node implementing the EES.

At block 910, a registration request or a registration update request is transmitted to an ECS. The registration request or registration update request contains one or more DNAIs associated with the EES or an EAS that is registered with the EES.

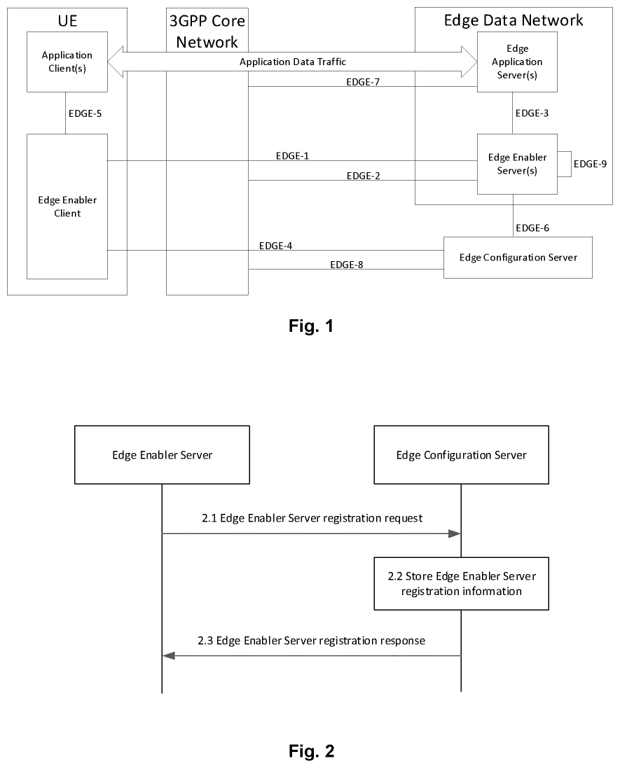

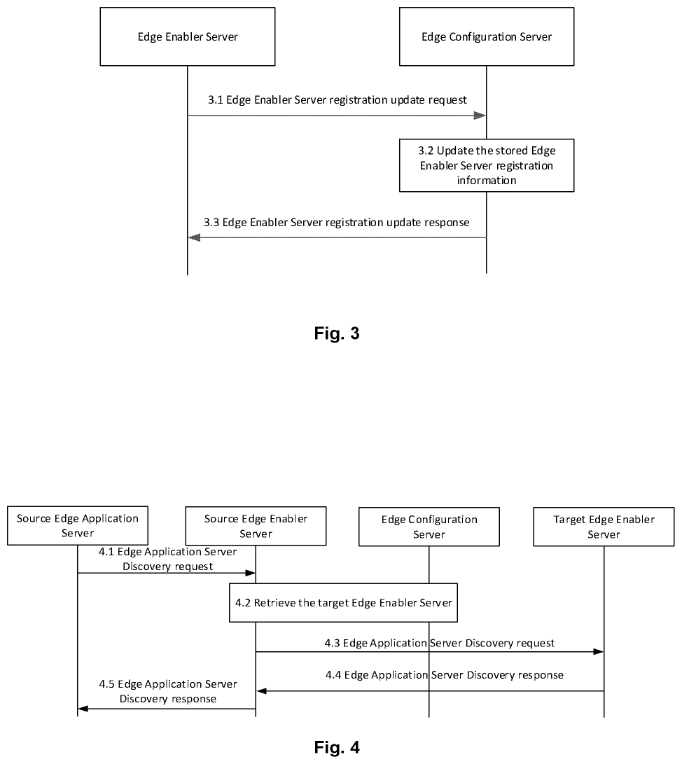

Here, the registration request can be e.g., the EES registration request in the step 2.1 of FIG. 2, and the registration update request can be e.g., the EES registration update request in the step 3.1 of FIG. 3. For example, an EES registration update request may be used to update one or more DNAIs included in a previous EES registration request.

In an example, the one or more DNAIs may be included in an EES profile or an EAS profile in the registration request or the registration update request. For example, the EES profile defined in Section 8.2.6 of TS 23.558 can be extended to include the one or more DNAIs, as shown in Table 1 below.

TABLE 1
Edge Enabler Server Profile

| Information element | Status | Description |
|---|---|---|
| EES ID | M | The identifier of the EES |
| EES Endpoint | M | Endpoint information (e.g. URI, FQDN, IP address) used to |
| | | communicate with the EES. This information is provided to the EEC to |
| | | connect to the EES. |
| EES Provider Identifier | O | The identifier of the EES Provider (such as ECSP) |
| EAS information | M | List of EAS information |
| > EAS ID | M | Edge Application Server ID registered with the EES. |
| > EAS DNAI | O | DNAI associated to the EAS. This IE may be used as Potential |
| | | Locations of Applications in Section 5.6.7 of 3GPP TS 23.501. |

For further details of the EES profile, reference can be made to Table 8.2.6-1 of TS 23.558, and description thereof will be omitted here.

FIG. 10 is a flowchart illustrating a method 1000 according to an embodiment of the present disclosure. The method 1000 can be performed at an ECS or a network node implementing the ECS.

At block 1010, a registration request or a registration update request is received from an EES. The registration request or registration update request contains one or more DNAIs associated with the EES or an EAS that is registered with the EES.

Here, the registration request can be e.g., the EES registration request in the step 2.1 of FIG. 2, and the registration update request can be e.g., the EES registration update request in the step 3.1 of FIG. 3. For example, an EES registration update request may be used to update one or more DNAIs included in a previous EES registration request.

In an example, the one or more DNAIs may be included in an EES profile or an EAS profile in the registration request or the registration update request. For example, the EES profile defined in Section 8.2.6 of TS 23.558 can be extended to include the one or more DNAIs, as shown the above Table 1.

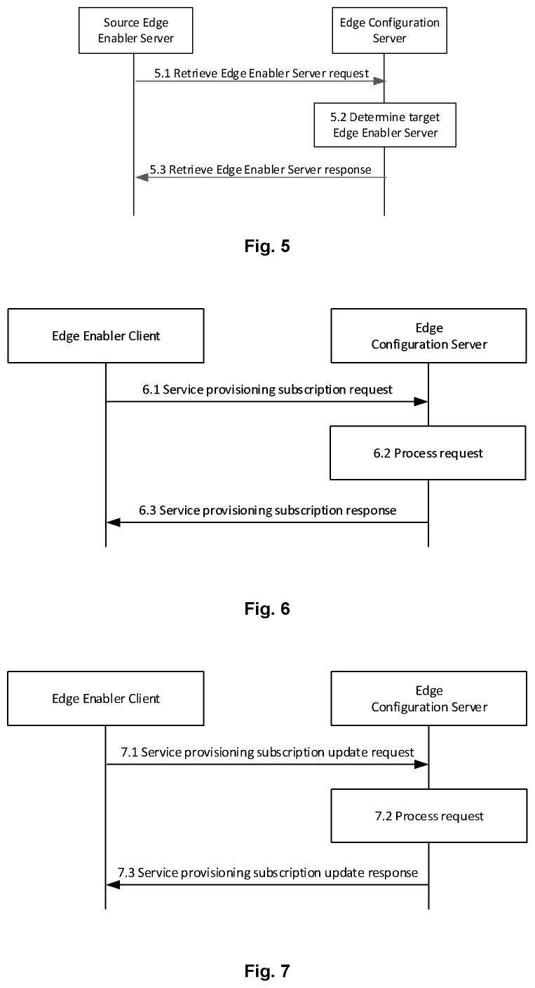

In an example, the ECS can receive, from a source EES (e.g., the source EES as shown in FIG. 5), a retrieve EES request for retrieving one or more target EESs. The retrieve EES request can contain a target DNAI. Then, the ECS can determine which EES has a registered EAS with a DNAI matching the target DNAI. The ECS can transmit, to the source EES, a retrieve EES response containing information on the one or more target EESs associated with the target DNAI. For example, when at least one of the one or more DNAIs received in the block 1010 match the target DNAI, the ECS can transmit, to the source EES, a retrieve EES response containing information on the EES as a target EES. Here, the retrieve EES request and the retrieve EES response may be e.g., the retrieve EES request and the retrieve EES response in the step 5.1 and the step 5.3 of FIG. 5, respectively.

In an example, the ECS can receive, from a terminal device implementing an EEC, a service provisioning subscription request or a service provisioning subscription update request containing EAS endpoint information of a selected EAS for application traffic. Here, the terminal device can be e.g., the UE hosting an EEC as shown in FIG. 1, and the selected EAS is an EAS that is using or to be used by the UE (Application Client) for the application traffic. The EAS endpoint information may include an IP address, a port number, a transport layer protocol, a FQDN, and/or a URI associated with the selected EAS.

The service provisioning subscription request can be e.g., a service provisioning subscription request in the step 6.1 of FIG. 6, extended to carry the EAS endpoint information, as shown in Table 2 below.

TABLE 2
Service provisioning subscription request

| Information element | Status | Description |
|---|---|---|
| EEC ID | M | Unique identifier of the EEC. |
| Security credentials | M | Security credentials resulting from a successful |
| | | authorization for the edge computing service. |
| Application Client profile(s) | M | Information about services the EEC wants to |
| | | connect to, as described in Table 8.2.2-1 of TS |
| | | 23.558. |
| UE Identifier | O | The identifier of the UE (i.e. GPSI or identity token) |
| EAS information | O | List of EAS information, it may be present when the |
| | | UE Identifier is provided. |
| > EAS Endpoint | M | Endpoint information (e.g. URI, FQDN, IP 3-tuple) |
| | | that Application Clients use to send requests to the |
| | | EAS. The ECS uses this IE and UE Identifier to |
| | | utilize the user plane path management capability |
| | | of the 3GPP core network as specified in Section |
| | | 8.9.2 of TS 23.558. |
| Connectivity information | O | List of connectivity information for the UE, e.g. |
| | | PLMN ID, SSID. |
| Proposed expiration time | O | Proposed expiration time for the subscription |

For further details of the service provisioning subscription request, reference can be made to Table 8.3.3.3-1 of TS 23.558, and description thereof will be omitted here.

The service provisioning subscription update request can be e.g., a service provisioning subscription update request in the step 7.1 of FIG. 7, extended to carry the EAS endpoint information, as shown in Table 3 below.

TABLE 3
Service provisioning subscription update request

| Information element | Status | Description |
|---|---|---|
| Subscription ID | M | Subscription identifier corresponding to the |
| | | subscription to be updated |
| Security credentials | M | Security credentials resulting from a successful |
| | | authorization for the edge computing service. |
| Connectivity information | O | Details about the connectivity of the UE with the |
| | | PLMN, such as type of the 3GPP network. |
| Proposed expiration time | O | Proposed expiration time for the subscription |
| Application Client profile(s) | O | Information about services the EEC wants to |
| | | connect to, as described in Table 8.2.2-1 of TS |
| | | 23.558. |
| EAS information | O | List of EAS information |
| > EAS Endpoint | M | Endpoint information (e.g. URI, FQDN, IP 3-tuple) |
| | | that Application Clients use to send requests to the |
| | | EAS. The EEC may update the EAS in use after |
| | | changing EAS. |

For further details of the service provisioning subscription update request, reference can be made to Table 8.3.3.6-1 of TS 23.558, and description thereof will be omitted here.

For example, a service provisioning subscription update request may be used to update EAS endpoint information included in a previous service provisioning subscription request.

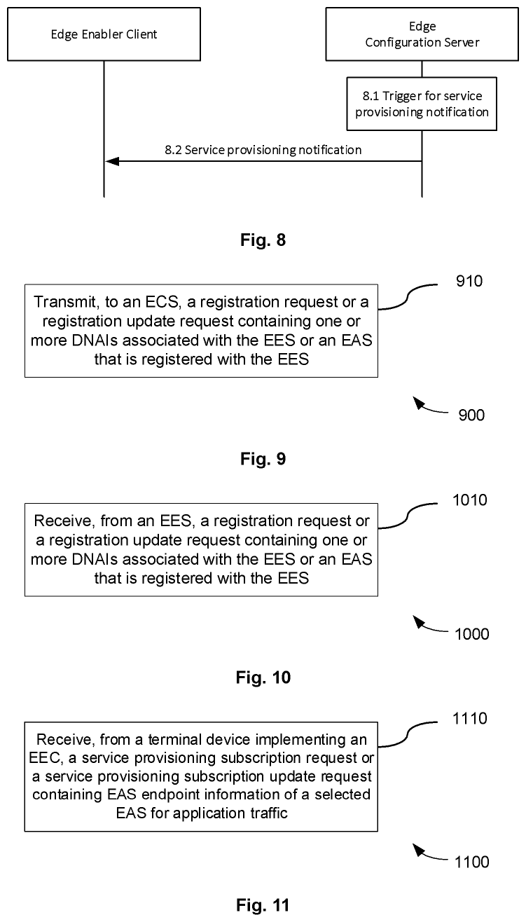

After receiving the EAS endpoint information, the ECS can use this information and a UE ID (which can also be included in the service provisioning subscription request or service provisioning subscription update request) to utilize the UP path management capability of the 3GPP CN as defined in Section 8.9.2 of TS 23.558. When a supervised path for the application traffic changes, the ECS can receive, from a CN node (e.g., a Network Exposure Function (NEF) or Session Management Function (SMF) node), a notification of a UP path management event (e.g., DNAI change) associated with the application traffic. The notification can contain a target DNAI for the application traffic. Then, the ECS can determine which EES has a registered EAS with a DNAI matching the target DNAI. For example, when at least one of the one or more DNAIs received in the block 1010 match the target DNAI, the ECS can transmit, to the terminal device (EEC), a service provisioning notification containing information on the EES. Here, the service provisioning notification can be e.g., the service provisioning notification in the step 8.2 of FIG. 8.

FIG. 11 is a flowchart illustrating a method 1100 according to an embodiment of the present disclosure. The method 1100 can be performed at an ECS or a network node implementing the ECS.

At block 1110, a service provisioning subscription request or a service provisioning subscription update request is received from a terminal device implementing an EEC. The service provisioning subscription request or service provisioning subscription update request contains EAS endpoint information of a selected EAS for application traffic. Here, the terminal device can be e.g., the UE hosting an EEC as shown in FIG. 1, and the selected EAS is an EAS that is using or to be used by the UE (Application Client) for the application traffic. The EAS endpoint information may include an IP address, a port number, a transport layer protocol, a FQDN, and/or a URI associated with the selected EAS.

The service provisioning subscription request can be e.g., a service provisioning subscription request in the step 6.1 of FIG. 6, extended to carry the EAS endpoint information, as shown in the above Table 2. The service provisioning subscription update request can be e.g., a service provisioning subscription update request in the step 7.1 of FIG. 7, extended to carry the EAS endpoint information, as shown in the above Table 3. For example, a service provisioning subscription update request may be used to update EAS endpoint information included in a previous service provisioning subscription request.

In an example, after receiving the EAS endpoint information, the ECS can use this information and a UE ID (which can also be included in the service provisioning subscription request or service provisioning subscription update request) to utilize the UP path management capability of the 3GPP CN as defined in Section 8.9.2 of TS 23.558. When a supervised path for the application traffic changes, the ECS can receive, from a CN node (e.g., a NEF or SMF node), a notification of a UP path management event (e.g., DNAI change) associated with the application traffic. The notification can contain a target DNAI for the application traffic. Then, the ECS can determine which EES has a registered EAS with a DNAI matching the target DNAI. For example, when a DNAI associated with an EAS that is registered with an EES matches the target DNAI, the ECS can transmit, to the terminal device (EEC), a service provisioning notification containing information on the EES. Here, the EES has been registered with the ECS, and, as a non-limiting example, the ECS may have learned the DNAI associated with the EAS from the EES during its registration or registration update procedure (e.g., from the registration request or registration update request in the block 1010 of FIG. 10). Here, the service provisioning notification can be e.g., the service provisioning notification in the step 8.2 of FIG. 8.

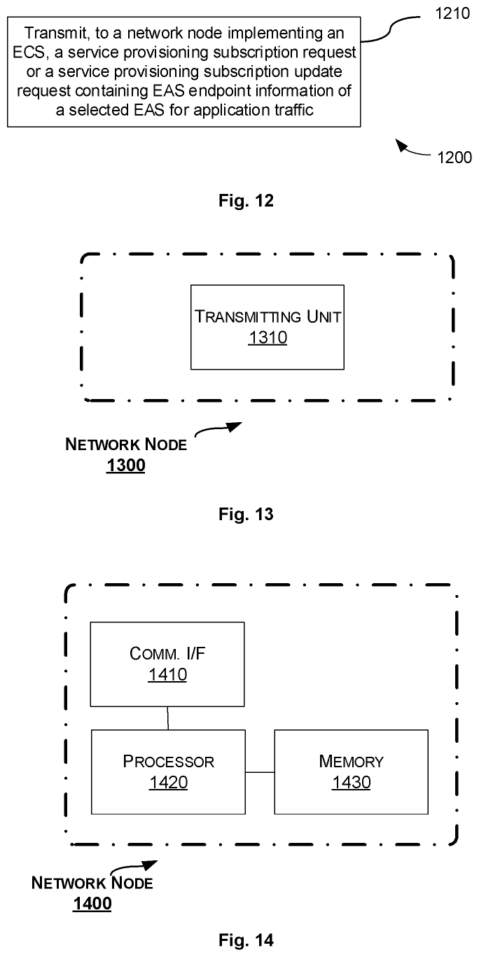

FIG. 12 is a flowchart illustrating a method 1200 according to an embodiment of the present disclosure. The method 1200 can be performed at a terminal device implementing an EEC.

At block 1210, a service provisioning subscription request or a service provisioning subscription update request is transmitted to a network node implementing an ECS. The service provisioning subscription request or service provisioning subscription update request contains EAS endpoint information of a selected EAS for application traffic. Here, the terminal device can be e.g., the UE hosting an EEC as shown in FIG. 1, and the selected EAS is an EAS that is using or to be used by the UE (Application Client) for the application traffic. The EAS endpoint information may include an IP address, a port number, a transport layer protocol, a FQDN, and/or a URI associated with the selected EAS.

The service provisioning subscription request can be e.g., a service provisioning subscription request in the step 6.1 of FIG. 6, extended to carry the EAS endpoint information, as shown in the above Table 2. The service provisioning subscription update request can be e.g., a service provisioning subscription update request in the step 7.1 of FIG. 7, extended to carry the EAS endpoint information, as shown in the above Table 3. For example, a service provisioning subscription update request may be used to update EAS endpoint information included in a previous service provisioning subscription request.

It is to be noted that, as both EAS and EES are Application Functions (AFs), the operations/features described in the above methods 900˜1200 in connection with an EAS DNAI are also applicable to an EES DNAI, the operations/features described in the above methods 900˜1200 in connection with an EAS endpoint are also applicable to an EES endpoint.

Correspondingly to the method 900 as described above, a network node is provided. FIG. 13 is a block diagram of a network node 1300 according to an embodiment of the present disclosure. The network node 1300 can be configured to implement an EES.

As shown in FIG. 13, the network node 1300 includes a transmitting unit 1310 configured to transmit, to an ECS, a registration request or a registration update request containing one or more DNAIs associated with an EAS or the EES. The EAS is registered with the EES.

In an embodiment, the one or more DNAIs may be included in an EES profile or an EAS profile in the registration request or the registration update request.

The unit 1310 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 9.

FIG. 14 is a block diagram of a network node 1400 according to another embodiment of the present disclosure. The network node 1400 can be configured to implement an EES. The network node 1400 includes a communication interface 1410, a processor 1420 and a memory 1430. The memory 1430 may contain instructions executable by the processor 1420 whereby the network node 1400 is operative to, when implementing an EES, perform the actions, e.g., of the procedure described earlier in conjunction with FIG. 9. Particularly, the memory 1430 may contain instructions executable by the processor 1420 whereby the network node 1400 is operative to, when implementing an EES: transmit, to an ECS, a registration request or a registration update request containing one or more DNAIs associated with the EES or an EAS that is registered with the EES.

In an embodiment, the one or more DNAIs may be included in an EES profile or an EAS profile in the registration request or the registration update request.

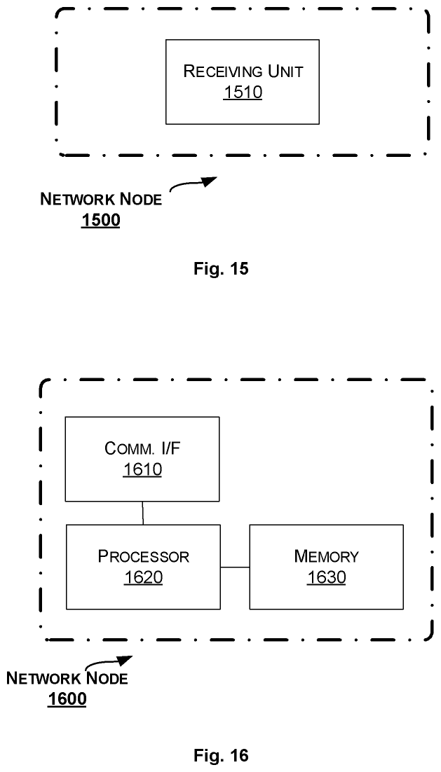

Correspondingly to the method 1000 or 1100 as described above, a network node is provided. FIG. 15 is a block diagram of a network node 1500 according to an embodiment of the present disclosure.

The network node 1500 can be configured to perform, when implementing an ECS, the method 1000 as described above in connection with FIG. 10. The network node 1500 includes a receiving unit 1510 configured to receive, from an EES, a registration request or a registration update request containing one or more DNAIs associated with the EES or an EAS that is registered with the EES.

In an embodiment, the one or more DNAIs may be included in an EES profile an EAS profile in the registration request or the registration update request.

In an embodiment, the receiving unit 1510 can be further configured to receive, from a source EES, a retrieve EES request for retrieving one or more target EESs, the retrieve EES request containing a target DNAI. The network node 1500 can further include a transmitting unit configured to transmit, to the source EES, a retrieve EES response containing information on the one or more target EESs associated with the target DNAI.

In an embodiment, at least one of the one or more DNAIs associated with the EAS or EES may match the target DNAI.

In an embodiment, the receiving unit 1510 can be further configured to: receive, from a terminal device implementing an EEC, a service provisioning subscription request or a service provisioning subscription update request containing EAS endpoint information of a selected EAS for application traffic; and receive, from a CN node, a notification of a UP path management event associated with the application traffic, the notification containing a target DNAI for the application traffic. The network node 1500 can further include a transmitting unit configured to transmit, to the terminal device, a service provisioning notification containing information on the EES, when at least one of the one or more DNAIs associated with the EAS or the EES match the target DNAI.

In an embodiment, the UP path management event may include DNAI change.

In an embodiment, the EAS endpoint information may include an IP address, a port number, a transport layer protocol, a FQDN, and/or a URI associated with the selected EAS.

Alternatively, the network node 1500 can be configured to perform, when implementing an ECS, the method 1100 as described above in connection with FIG. 11. The network node 1500 includes a receiving unit 1510 configured to receive, from a terminal device implementing an EEC, a service provisioning subscription request or a service provisioning subscription update request containing EAS endpoint information of a selected EAS for application traffic.

In an embodiment, the receiving unit 1510 can be configured to receive, from a CN node, a notification of a UP path management event associated with the application traffic, the notification containing a target DNAI for the application traffic. The network node 1500 can further include a transmitting unit configured to transmit, to the terminal device, a service provisioning notification containing information on an EES when a DNAI associated with an EAS matches the target DNAI. The EAS is registered with the EES.

In an embodiment, the UP path management event may include DNAI change.

In an embodiment, the EAS endpoint information may include an IP address, a port number, a transport layer protocol, a FQDN, and/or a URI associated with the selected EAS.

The unit 1510 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 10 or 11.

FIG. 16 is a block diagram of a network node 1600 according to another embodiment of the present disclosure.

The network node 1600 includes a communication interface 1610, a processor 1620 and a memory 1630.

The memory 1630 may contain instructions executable by the processor 1620 whereby the network node 1600 is operative to, when implementing an ECS, perform the actions, e.g., of the procedure described earlier in conjunction with FIG. 10. Particularly, the memory 1630 may contain instructions executable by the processor 1620 whereby the network node 1600 is operative to, when implementing an ECS: receive, from an EES, a registration request or a registration update request containing one or more DNAIs associated with the EES or an EAS that is registered with the EES.

In an embodiment, the one or more DNAIs may be included in an EES profile or an EAS profile in the registration request or the registration update request.

In an embodiment, the memory 1630 may further contain instructions executable by the processor 1620 whereby the network node 1600 is operative to, when implementing the ECS: receive, from a source EES, a retrieve EES request for retrieving one or more target EESs, the retrieve EES request containing a target DNAI; and transmit, to the source EES, a retrieve EES response containing information on the one or more target EESs associated with the target DNAI.

In an embodiment, at least one of the one or more DNAIs associated with the EAS or EES may match the target DNAI.

In an embodiment, the memory 1630 may further contain instructions executable by the processor 1620 whereby the network node 1600 is operative to, when implementing the ECS: receive, from a terminal device implementing an EEC, a service provisioning subscription request or a service provisioning subscription update request containing EAS endpoint information of a selected EAS for application traffic; receive, from a CN node, a notification of a UP path management event associated with the application traffic, the notification containing a target DNAI for the application traffic; and transmit, to the terminal device, a service provisioning notification containing information on the EES, when at least one of the one or more DNAIs associated with the EAS or the EES match the target DNAI.

In an embodiment, the UP path management event may include DNAI change.

In an embodiment, the EAS endpoint information may include an IP address, a port number, a transport layer protocol, a FQDN, and/or a URI associated with the selected EAS.

Alternatively, the memory 1630 may contain instructions executable by the processor 1620 whereby the network node 1600 is operative to, when implementing an ECS, perform the actions, e.g., of the procedure described earlier in conjunction with FIG. 11. Particularly, the memory 1630 may contain instructions executable by the processor 1620 whereby the network node 1600 is operative to, when implementing an ECS: receive, from a terminal device implementing an EEC, a service provisioning subscription request or a service provisioning subscription update request containing EAS endpoint information of a selected EAS for application traffic.

In an embodiment, the memory 1630 may further contain instructions executable by the processor 1620 whereby the network node 1600 is operative to, when implementing the ECS: receive, from a CN node, a notification of a UP path management event associated with the application traffic, the notification containing a target DNAI for the application traffic; and transmit, to the terminal device, a service provisioning notification containing information on an EES when a DNAI associated with an EAS matches the target DNAI. The EAS is registered with the EES.

In an embodiment, the UP path management event may include DNAI change.

In an embodiment, the EAS endpoint information may include an IP address, a port number, a transport layer protocol, a FQDN, and/or a URI associated with the selected EAS.

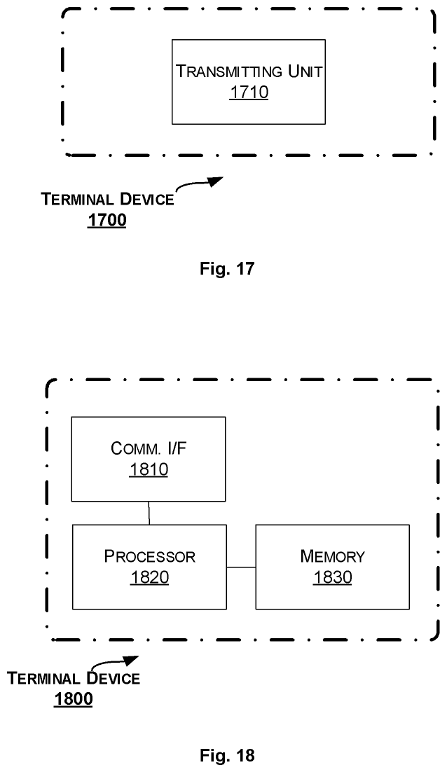

Correspondingly to the method 1200 as described above, a terminal device is provided. FIG. 17 is a block diagram of a terminal device 1700 according to an embodiment of the present disclosure. The terminal device 1700 can be configured to implement an EEC.

As shown in FIG. 17, the terminal device 1700 includes a transmitting unit 1710 configured to transmit, to a network node implementing an ECS, a service provisioning subscription request or a service provisioning subscription update request containing EAS endpoint information of a selected EAS for application traffic.

In an embodiment, the EAS endpoint information may include an IP address, a port number, a transport layer protocol, a FQDN, and/or a URI associated with the selected EAS.

The unit 1710 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 12.

FIG. 18 is a block diagram of a terminal device 1800 according to another embodiment of the present disclosure. The terminal device 1800 can be configured to implement an EEC. The terminal device 1800 includes a communication interface 1810, a processor 1820 and a memory 1830. The memory 1830 may contain instructions executable by the processor 1820 whereby the terminal device 1800 is operative to, when implementing an EEC, perform the actions, e.g., of the procedure described earlier in conjunction with FIG. 12. Particularly, the memory 1830 may contain instructions executable by the processor 1820 whereby the terminal device 1800 is operative to, when implementing an EEC: transmit, to a network node implementing an ECS, a service provisioning subscription request or a service provisioning subscription update request containing EAS endpoint information of a selected EAS for application traffic.

In an embodiment, the EAS endpoint information may include an IP address, a port number, a transport layer protocol, a FQDN, and/or a URI associated with the selected EAS.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1420 causes the network node 1400 to perform the actions, e.g., of the procedure described earlier in conjunction with FIG. 9, or code/computer readable instructions, which when executed by the processor 1620 causes the network node 1600 to perform the actions, e.g., of the procedure described earlier in conjunction with FIG. 10 or 11, code/computer readable instructions, which when executed by the processor 1820 causes the terminal device 1800 to perform the actions, e.g., of the procedure described earlier in conjunction with FIG. 12,.

The computer program product may be configured as a computer program code structured in computer program modules. The computer program modules could essentially perform the actions of the flow illustrated in FIG. 9, 10, 11, or 12.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-21. (canceled)

22. A method in a network node implementing an Edge Enabler Server, EES, comprising:
transmitting, to an Edge Configuration Server, ECS, an EES registration request or an EES registration update request containing one or more Data Network Access Identifiers, DNAIs, associated with an Edge Application Server, EAS, or the EES, wherein the EAS is registered with the EES.

23. The method of claim 22, wherein the one or more DNAIs are included in an EES profile or an EAS profile in the registration request or the registration update request.

24. A method in a network node implementing an Edge Configuration Server, ECS, comprising:
receiving, from an Edge Enabler Server, EES, an EES registration request or an EES registration update request containing one or more Data Network Access Identifiers, DNAIs, associated with an Edge Application Server, EAS, or the EES, wherein the EAS is registered with the EES.

25. The method of claim 24, wherein the one or more DNAIs are included in an EES profile or an EAS profile in the registration request or the registration update request.

26. The method of claim 24, further comprising:
receiving, from a source EES, a retrieve EES request for retrieving one or more target EESs, the retrieve EES request containing a target DNAI; and
transmitting, to the source EES, a retrieve EES response containing information on the one or more target EESs associated with the target DNAI.

27. The method of claim 26, wherein at least one of the one or more DNAIs associated with the EAS or EES match the target DNAI.

28. The method of claim 24, further comprising:
receiving, from a terminal device implementing an Edge Enabler Client, EEC, a service provisioning subscription request or a service provisioning subscription update request containing EAS endpoint information of a selected EAS for application traffic;
receiving, from a Core Network, CN, node, a notification of a User Plane, UP, path management event associated with the application traffic, the notification containing a target DNAI for the application traffic; and
transmitting, to the terminal device, a service provisioning notification containing information on the EES, when at least one of the one or more DNAIs associated with the EAS or the EES match the target DNAI.

29. The method of claim 28, wherein the UP path management event comprises DNAI change.

30. The method of claim 28, wherein the EAS endpoint information comprises an Internet Protocol, IP, address, a port number, a transport layer protocol, a Fully Qualified Domain Name, FQDN, and/or a Uniform Resource Identifier, URI, associated with the selected EAS.

31. A network node, comprising a communication interface, a processor and a memory, the memory comprising instructions executable by the processor whereby the network node is operative to, when implementing an Edge Enabler Server, EES:
transmit, to an Edge Configuration Server, ECS, an EES registration request or an EES registration update request containing one or more Data Network Access Identifiers, DNAIs, associated with an Edge Application Server, EAS, or the EES, wherein the EAS is registered with the EES.

32. A computer-readable storage medium having computer-readable instructions stored thereon, the computer-readable instructions, when executed by a processor of a network node, configure the network node to, when implementing an Edge Enabler Server, EES:
transmit, to an Edge Configuration Server, ECS, an EES registration request or an EES registration update request containing one or more Data Network Access Identifiers, DNAIs, associated with an Edge Application Server, EAS, or the EES, wherein the EAS is registered with the EES.

33. A network node, comprising a communication interface, a processor and a memory, the memory comprising instructions executable by the processor whereby the network node is operative to, when implementing an Edge Configuration Server, ECS:
receive, from an Edge Enabler Server, EES, an EES registration request or an EES registration update request containing one or more Data Network Access Identifiers, DNAIs, associated with an Edge Application Server, EAS, or the EES, wherein the EAS is registered with the EES.

34. A computer-readable storage medium having computer-readable instructions stored thereon, the computer-readable instructions, when executed by a processor of a network node, configure the network node to, when implementing an Edge Configuration Server, ECS:
receive, from an Edge Enabler Server, EES, an EES registration request or an EES registration update request containing one or more Data Network Access Identifiers, DNAIs, associated with an Edge Application Server, EAS, or the EES, wherein the EAS is registered with the EES.
